(19) United States
(12) Patent Application Publication
(10) Pub. No.: US 2011/0138453 A1
(43) Pub. Date: Jun. 9, 2011

(54) SINGLE SIGN-ON IN MIXED HTTP AND SIP ENVIRONMENTS

(75) Inventors: Sanjeev VERMA, San Jose, CA (US); Alan MESSER, Los Gatos, CA (US)

(73) Assignee: SAMSUNG ELECTRONICS CO., LTD., Suwon City (KR)

(21) Appl. No.: 12/941,745

(22) Filed: Nov. 8, 2010

Related U.S. Application Data
(60) Provisional application No. 61/266,486, filed on Dec. 3, 2009.
(60) Provisional application No. 61/295,614, filed on Jan. 15, 2010.
(60) Provisional application No. 61/323,632, filed on Apr. 13, 2010.

(51) Int. Cl. H04L 9/32

(52) U.S. Cl. 726/8

(57) ABSTRACT

In a first embodiment of the present invention, a method for providing single sign-on in a network having a HyperText Transfer Protocol (HTTP) portion and a Session Initiation Protocol (SIP) portion is provided, the method performed at a gateway and comprising: receiving an HTTP request for an assertion from a requester over the HTTP portion; generating a SIP request using the request for assertion; sending the SIP request to a SIP registrar over the SIP portion; receiving a SIP response including information regarding an assertion from the SIP registrar; and sending the information regarding the assertion in an HTTP response to the requester, such that the requester can use the information regarding the assertion in authenticating the requester to a web server.

### CROSS REFERENCE TO RELATED APPLICATIONS

This application claims the benefit or priority under 35 U.S.C. 119(e) to U.S. Provisional Patent Application Nos. 61/266,486, filed Dec. 3, 2009; 61/295,614, filed Jan. 15, 2010; and 61/323,632, filed Apr. 13, 2010. All of the above-identified applications are incorporated herein by reference for all purposes.

### BACKGROUND OF THE INVENTION

1. Field of the Invention

The present invention relates to computer science. More specifically the present invention relates to providing for a single sign-on in a network environment that includes both HTTP and SIP environments.

2. Description of the Related Art

Single Sign-On (SSO) is becoming an important requirement with the emergence of distributed services. SSO is a property of access control of multiple, related, but independent software systems. With this property a user logs in once and gains access to all systems without being prompted to log in again at each of them. Ideally clients would be required to prove their identities only once and free to access subsequent services without additional authentication. There have been several proprietary and non-proprietary SSO solutions for the web-based environments using Hypertext Transfer Protocol (HTTP) protocol. However, there is need to address SSO problem in mixed environments where multiple protocols are being deployed. One such scenario is the Open Internet Protocol Television (IPTV) managed network scenario that deploys both HTTP and Session Initiation Protocol (SIP) protocols.

IPTV is a system through which Internet television services are delivered using the architecture and networking methods of the Internet Protocol Suite over a packet-switched network infrastructure, e.g., the Internet and broadband Internet access networks, instead of being delivered through traditional radio frequency broadcast, satellite signal, and cable television formats. IPTV is defined as multimedia services such as television/video/audio/text/graphics/data delivered over IP based networks managed to provide the required level of quality of service and experience, security, interactivity and reliability.

The Open IPTV Forum was created to provide an IPTV solution enabling a “plug and play” experience for the end-users and filling a industry gap making it independent from the technology behind it.

Current Open IPTV Television Function (OIPF) managed networks use Generic Bootstrapping Architecture (GBA-based SSO). FIG. 1 is a diagram illustrating an example GBA single sign-on architecture. This architecture uses the existing authentication schemes that are deployed to register an IPTV Terminal Function (ITF), which is essentially the client, to the network, and to register the shared secret between the ITF and certain network entities.

An ITF 100 that desires to establish a secure channel 102 with an Application Server (AS) 104 before accessing the service must acquire a key to share. To that end, the ITF 100 authenticates itself to a trusted node in the network dedicated for that purpose. This is the role of the GBA Single Sign-on function. Once successfully authenticated with the GBA Single Sign-on function, the ITF 100 locally generates a master key for generating the key to be shared with the AS 104. The Single Sign-on Functional Entity (FE) performs the same procedure and generates the same master key.

In order to allow the ITF 100 to share separate keys with the different ASs with whom it wants to communicate, the AS address can be used in the generation of the shared key in combination with the master key. Later on, when the ITF 100 attempts to activate the service, mutual authentication 106 is required with the AS. Server certificates are used by the ITF to authenticate the AS. Following that, a secure channel 102 can be established. Once the secure channel is set up, the user is authenticated by the AS 104 using the shared key. The ITF 100 uses the shared secret as a password, and the AS can fetch the same key 108 from the GBA Single Sign-on function. Once mutual authentication is successfully concluded by the AS 104, it can verify if the user is authorized for the service.

FIG. 2 is call flow diagram illustrating the above procedure. At 200, the ITF 202 authenticates itself with the GBA Single Sign-on function using the same credentials used in the IMS registration process. At 204, the ITF 200 generates a master key locally and uses that key to generate separate keys for all ASs with whom it desires to communicate. At 206, the GBA Single Sign-on function 208 performs the same process. At 210, the ITF establishes a secure channel with the AS 212 using the AS's public server certificate for that purpose. At 214, the AS 212 fetches the shared key for that user from the GBA Single Sign-on function 208. At 216, the ITF 202 then uses the shared key with the AS 212 as its password to authenticate itself. The AS 212 compares the received password with the one fetched from the GBA Single Sign-on function 208. At 218, mutual authentication is now completed and signaling exchange can start.

The GBA-based solution outlined above is a common HTTP-based solution to the single sign on problem. However, the GBA-based solution requires Universal Integrated Circuit Card (UICC), or Smart Card, support in every deployed Internet Gateway (IG). This adds to the cost of Service Provider. Many network implementations nowadays include a combination of HTTP and SIP environments. For example, devices linked in a home network, such as computers and televisions, often communicate in an HTTP environment. However, mobile devices, such as mobile phones, often communication in an SIP environment. SIP can support a variety of communication services, like VoIP (Voice over IP), SIP conferencing and Instant Messaging (IM). As mobile phones have gained more and more computing power, there is a trend towards having more and more computer-like functions embedded into mobile phones, and to allow for mobile phones operating in an SIP environment to communicate with computers operating in an HTTP environment. As such, mixed SIP-HTTP environments have been growing in popularity and will continue to increase in popularity for the near future.

To that same extent, users now utilize mobile phones and computing devices to access a wide variety of web sites. Many tasks that were traditionally performed in person, such as banking, shopping, and playing games, are now commonly performed over the Internet or via mobile phones. While a decade ago, entering a user name and password each time a different secure web site was visited was not as big a deal as it is today, when it is quite common for each user to visit many different such secure web sites in a single day. As such, single sign-on mechanisms are much more important today than they were previously, and promise to be even more important in the future, as more and more tasks are performed via the Internet or mobile phone.

What is needed is a solution that allows for single sign-on in a mixed HTTP and SIP environment.

### SUMMARY OF THE INVENTION

In a first embodiment of the present invention, a method for providing single sign-on in a network having a HyperText Transfer Protocol (HTTP) portion and a Session Initiation Protocol (SIP) portion is provided, the method performed at a gateway and comprising: receiving an HTTP request for an assertion from a requester over the HTTP portion; generating a SIP request using the request for assertion; sending the SIP request to a SIP registrar over the SIP portion; receiving a SIP response including information regarding an assertion from the SIP registrar; and sending the information regarding the assertion in an HTTP response to the requester, such that the requester can use the information regarding the assertion in authenticating the requester to a web server.

In a second embodiment of the present invention, a method for providing single sign-on in a network having a HyperText Transfer Protocol (HTTP) portion and a Session Initiation Protocol (SIP) portion is provided, the method performed at a gateway and comprising: receiving a minting assertion from a SIP registrar via the SIP portion; receiving an HTTP request for an assertion from a requester over the HTTP portion; generating a minted assertion and signing the minted assertion with a public key specific to a web server; generating an HTTP response including the minted assertion; and sending the HTTP response to the requester, such that the requester can provide the minted assertion to the web server in order to authenticate the requester.

In a third embodiment of the present invention, a system is provided comprising: a requesting device; a gateway connected to the requesting device via an HTTP link; a SIP registrar connected to the gateway via a SIP link; wherein the gateway is configured to: receive an HTTP request for an assertion from a requester over the HTTP link; generate a SIP request using the request for assertion; send the SIP request to a SIP registrar over the SIP link; receive a SIP response including information regarding an assertion from the SIP registrar; and send the information regarding the assertion in an HTTP response to the requester, such that the requester can use the information regarding the assertion in authenticating the requester to a web server.

In a fourth embodiment of the present invention, a system is provided comprising: a requesting device; a gateway connected to the requesting device via an HTTP link; a SIP registrar connected to the gateway via a SIP link; wherein the gateway is configured to: receive a minting assertion from a SIP registrar via the SIP link; receive an HTTP request for an assertion from a requester over the HTTP link; generate a minted assertion and signing the minted assertion with a public key specific to a web server; generate an HTTP response including the minted assertion; and send the HTTP response to the requester, such that the requester can provide the minted assertion to the web server in order to authenticate the requester.

In a fifth embodiment of the present invention, a gateway for providing single sign-on in a network having a HyperText Transfer Protocol (HTTP) portion and a Session Initiation Protocol (SIP) portion is provided, the gateway comprising: means for receiving an HTTP request for an assertion from a requester over the HTTP portion; means for generating a SIP request using the request for assertion; means for sending the SIP request to a SIP registrar over the SIP portion; means for receiving a SIP response including information regarding an assertion from the SIP registrar; and means for sending the information regarding the assertion in an HTTP response to the requester, such that the requester can use the information regarding the assertion in authenticating the requester to a web server.

In a sixth embodiment of the present invention, a gateway for providing single sign-on in a network having a HyperText Transfer Protocol (HTTP) portion and a Session Initiation Protocol (SIP) portion is provided, the gateway comprising: means for receiving a minting assertion from a SIP registrar via the SIP portion; means for receiving an HTTP request for an assertion from a requester over the HTTP portion; means for generating a minted assertion and signing the minted assertion with a public key specific to a web server; means for generating an HTTP response including the minted assertion; and means for sending the HTTP response to the requester, such that the requester can provide the minted assertion to the web server in order to authenticate the requester.

In a seventh embodiment of the present invention, a program storage cloud platform readable by a machine tangibly embodying a program of instructions executable by the machine to perform a method for providing single sign-on in a network having a HyperText Transfer Protocol (HTTP) portion and a Session Initiation Protocol (SIP) portion is provided, the method performed at a gateway and comprising: receiving an HTTP request for an assertion from a requester over the HTTP portion; generating a SIP request using the request for assertion; sending the SIP request to a SIP registrar over the SIP portion; receiving a SIP response including information regarding an assertion from the SIP registrar; and sending the information regarding the assertion in an HTTP response to the requester, such that the requester can use the information regarding the assertion in authenticating the requester to a web server.

In an eighth embodiment of the present invention, a program storage cloud platform readable by a machine tangibly embodying a program of instructions executable by the machine to perform a method for providing single sign-on in a network having a HyperText Transfer Protocol (HTTP) portion and a Session Initiation Protocol (SIP) portion is provided, the method performed at a gateway and comprising: receiving a minting assertion from a SIP registrar via the SIP portion; receiving an HTTP request for an assertion from a requester over the HTTP portion; generating a minted assertion and signing the minted assertion with a public key specific to a web server; generating an HTTP response including the minted assertion; and sending the HTTP response to the requester, such that the requester can provide the minted assertion to the web server in order to authenticate the requester.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a diagram illustrating an example GBA single sign-on architecture.

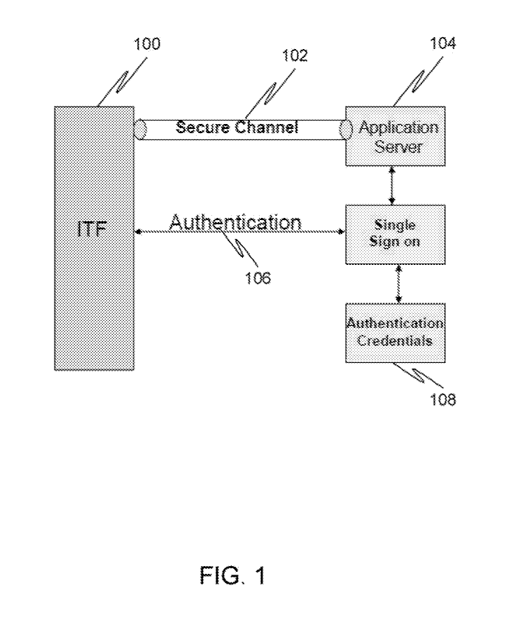

FIG. 2 is call flow diagram illustrating the example GBA single sign-on architecture.

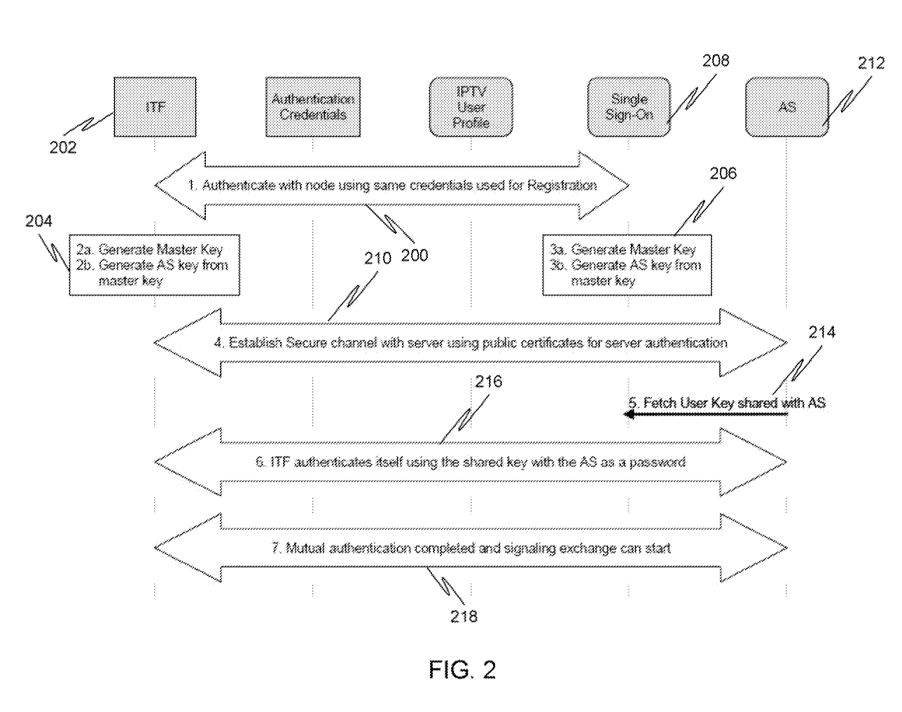

FIG. 3 is a diagram illustrating the embedding of SAML assertion in a SOAP body in accordance with an embodiment of the present invention.

FIG. 4 is a call flow diagram illustrating a process in accordance with the first subembodiment of the first embodiment of the present invention.

FIG. 5 is a call flow diagram illustrating a process in accordance with the second subembodiment of the first embodiment of the present invention.

FIG. 6 is a flow diagram illustrating a generic method covering both the first and the second subembodiments of the first embodiment of the present invention.

FIG. 7 is a call flow diagram illustrating a process in accordance with the second embodiment of the present invention.

FIG. 8 is a flow diagram illustrating a method for providing single-sign on in accordance with the second main embodiment of the present invention (delegation).

### DETAILED DESCRIPTION OF THE INVENTION

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

An embodiment of the present invention uses Simple Abstract Request/Response (SAML) protocol-based assertion mechanisms to provide for single sign-on in a mixed HTTP and SIP environment. SAML based SSO is an Industry Standard solution in HTTP-based web services. It can be bound to any underlying protocol such as HTTP or Session Initiation Protocol (SIP). It can also be profiled for a particular use case (e.g., SAML HTTP based SSO profile). The present invention takes advantage of these aspects of SAML in order to overcome the limitations found in prior art solutions.

The advantages of SAML are that it is the industry standard solution for SSO, there is no password associated with SAML assertion, and it eliminates the risk of password theft due to phishing or other hacking attack. A SAML assertion, once received by the client, can be used to sign into relevant web services without the need to conduct an additional sign-on step. In that manner, the SAML assertion is similar to a certificate, in that it is a security document including a verification that the client is who he or she claims to be.

It will be appreciated that there are a number of different embodiments that can be utilized to implement the present invention. While several embodiments are described in the present disclosure, one of ordinary skill in the art will recognize that these embodiments are not intended to be limiting, and nothing in this disclosure shall be interpreted as limiting the scope of the claims to any particular embodiment, unless expressly stated.

There are two main embodiments described in the present disclosure. The first of these main embodiments is described in terms of two subembodiments, which will be described later. In the first main embodiment of the present invention, assertions are made directly to a SIP registrar (such as the identity provider). A requester calls for an assertion, and a response returns the requested assertion (or an error). SAML can be cast into particular contexts of use by binding it to the specific underlying protocols (HTTP or SIP, depending upon the situation) and profiling it for the specific use case at hand. As part of this embodiment, a new profile is created that uses SAML-SOAP and SOAP-SIP bindings to build mechanisms to handle the single-sign on assertions. This scenario assumes that the authentication service is provided by the service provider and needs minimal support by an Internet gateway (IG) device.

It should be noted that the term “requester” as used in the present disclosure shall be interpreted as any device that is requesting access to a service, specifically the device that makes a request to have an assertion assigned so that it may access the service without re-entering password or other sign on information.

A “SIP registrar” is a server in a SIP network that accepts and processes SIP REGISTER requests. The SIP registrar provides a location service which registers one or more IP addresses to a certain SIP URI, indicated by the sip: scheme, although other protocol schemes are possible (such as tel:). More than one user agent can register at the same URI, with the result that all registered user agents will receive a call to the SIP URI. SIP registrars are logical elements, and are commonly co-located with SIP proxies. But it is also possible and often good for network scalability to place this location service with a redirect server.

In a second main embodiment of the present invention, the SIP registrar delegates some of its functions to an Internet gateway (IG). The assertions therefore are not made directly to the SIP registrar, but are instead made to the IG to which the SIP registrar has delegated authority. Once again SAML is utilized in making the assertions. This scenario assumes that the authentication services is provided in the home network by the Internet gateway. The authentication service is delegated to the Internet gateway in the home by the service provider, and the Internet gateway issues the SAML assertion instead of the service provider.

An Internet gateway (or Internet gateway device) is a gateway that includes a number of automatic functions that make it easier to perform various tasks, such as learning a public IP address, enumerate existing port mappings, and add and remove port mappings. The IG runs a version of Internet Gateway Device Protocol, which supports such functions.

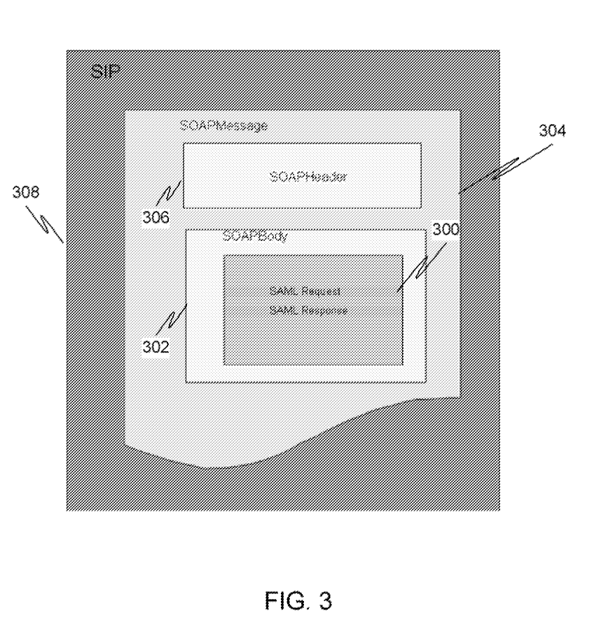

Referring to the first main embodiment, the inventors of the present invention noted that there is no direct way to carry SAML assertions in a SIP message, as would be required to communicate directly with the SIP registrar. As such, the inventors propose a solution where SAML assertions are carried in a Simple Object Access Protocol (SOAP) body. The SOAP body can then be embedded in the body of a SIP message via a defined SIP request method. In that manner, the SAML Request (and response) can be embedded into a SIP message. FIG. 3 is a diagram illustrating the embedding of SAML assertion in a SOAP body in accordance with an embodiment of the present invention. SAML Request 300 (and the corresponding SAML Response, in the case of the return message) is embedded within SOAP body 302. The SOAP message 304 then includes this SOAP body 302 and a SOAP header 306. The SOAP message 304 itself is then embedded within a SIP message 308.

As such, one of the subembodiments of the first main embodiment involves the embedding of SAML requests/responses in SIP messages. In that way, the SAML assertion is made directly to the SIP registrar. This may be known as the “assertion by value” embodiment.

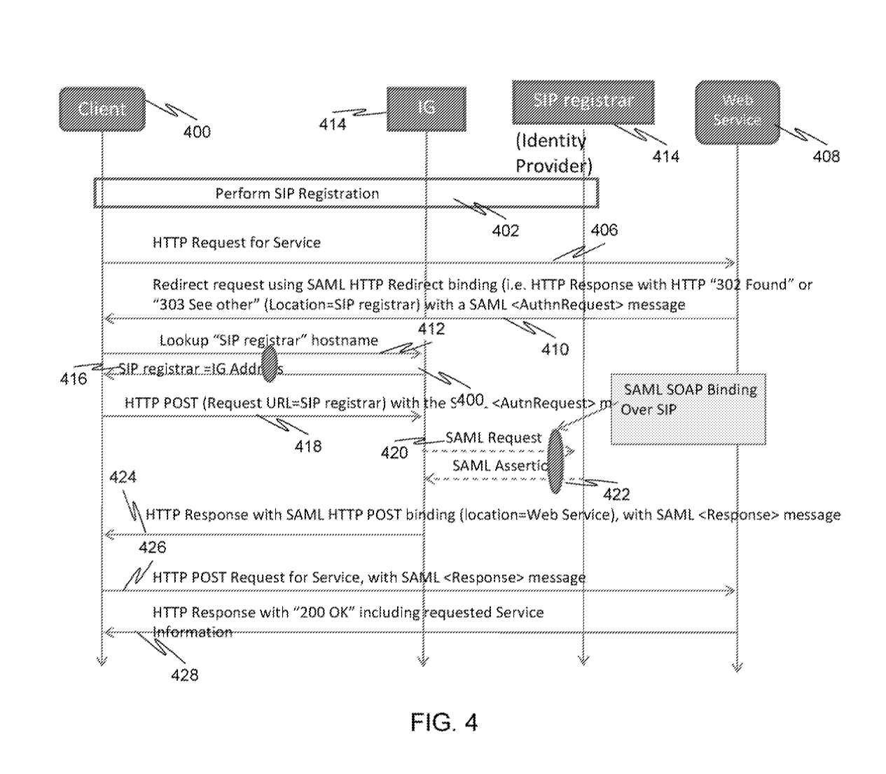

The aforementioned first subembodiment (assertion by value) is depicted in FIG. 4. As can be seen, a client 400 (requester, such as a television), can perform SIP registration 402 with the SIP registrar 404. The client 400 then issues an HTTP request for service 406 to the web service 408. The web service 408 issues an HTTP response 410 that includes a redirect request, which includes a SAML authorization request message. The client 400 then looks up the SIP registrar hostname 412 at the IG 414 and receives an IG address 416 corresponding to the SIP registrar 404. The client 400 then issues an HTTP request 418 with the SAML authorization request message to the appropriate IG 404. This is communicated via the HTTP protocol. The IG 414 then receives this message and encapsulates the SAML request in a SOAP body for use in a SIP message 420, which it then sends to the SIP registrar 404. The SIP registrar 404 then responds with a SAML assertion 422, which is also encapsulated in a SOAP body for use in a SIP message. The IG 414 then sends back an HTTP response 424 with a SAML HTTP Post binding and the SAML assertion. The client 400 is then able to post a request for service 426 directly with the web service 408 by including the SAML assertion, without the need to perform an additional sign-on step. After authenticating the client 400, the web service 408 can send an HTTP response with an “OK” message 428.

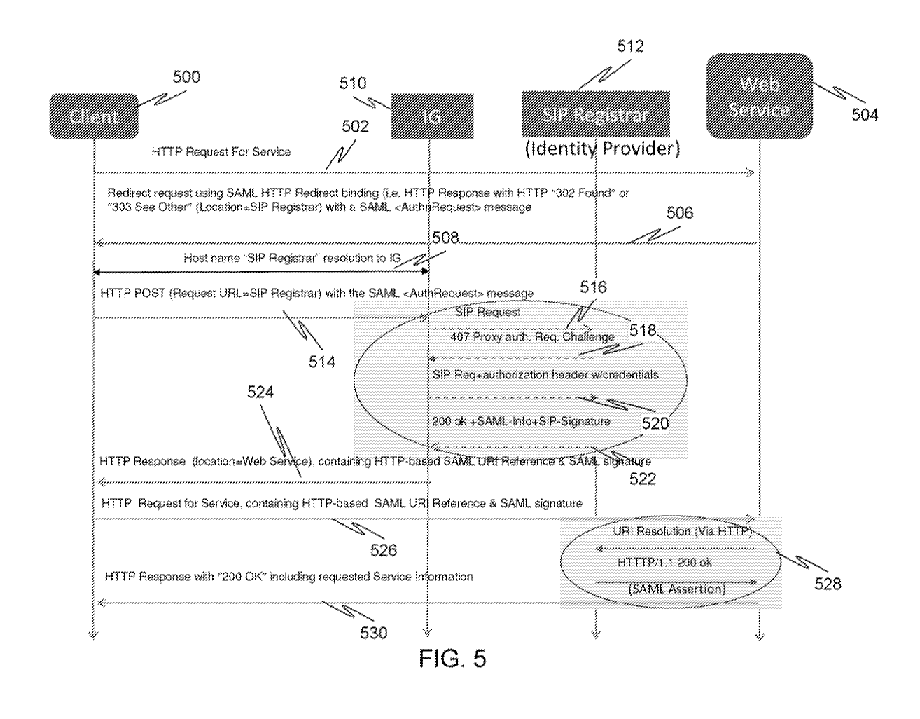

In a second subembodiment, however, the SAML assertion is not directly sent from the SIP registrar but rather the SIP registrar provides an address or link of the SAML assertion so that the SAML assertion can be retrieved by the web server upon request by the requester. This may be known as the “assertion fetch” embodiment. In this subembodiment, the SAML authority in the SIP registrar generates a SAML assertion and creates an HTTP-based SAML uniform resource identifier (URI) reference. The SIP registrar then puts the SAML reference into the SAML-Info header and returns this to the IG in response to the SIP request message. The SIP registrar also generates a digital signature and puts it in the SAML-signature header in order to tie the SAML-info field to the message. The SAML reference and signature is then sent to the web server from the requester through HTTP protocol messages. The web server then uses the SAML reference to retrieve the SAML assertion and verifies the SAML signature. This is depicted in FIG. 5.

Here, client 500 issues an HTTP Request for Service 502 to the web service 504. The web service 504 issues an HTTP response 506 that includes a redirect request, which includes a SAML authorization request message. The client 500 then looks up the SIP registrar 508 at the IG 510 and receives an IG address corresponding to the SIP registrar 512. The client 500 then issues an HTTP request 514 with the SAM authorization request message to the appropriate IG 510. This is communicated via the HTTP protocol. The IG 510 then receives this message and encapsulates the SAML request in a SOAP body for use in a SIP Request 516 that is sent to the SIP registrar 512. The SIP registrar 512 then responds with a proxy authorization request challenge 518. The IG 510 then issues a SIP request with an authorization header and credentials 520, and the IG 510 responds with a SIP response 522 that includes a link to the location of the SAML assertion. The IG 510 then includes this link in an HTTP response 524 back to the client 500. The client 500 is then able to post a request for service 526 directly with the web service 504, which uses the referenced link to retrieve the SAML assertion 528 and authorize the client 500. Once the client 500 has been authorized, the web service 504 can send an HTTP “OK” 530 response to the client.

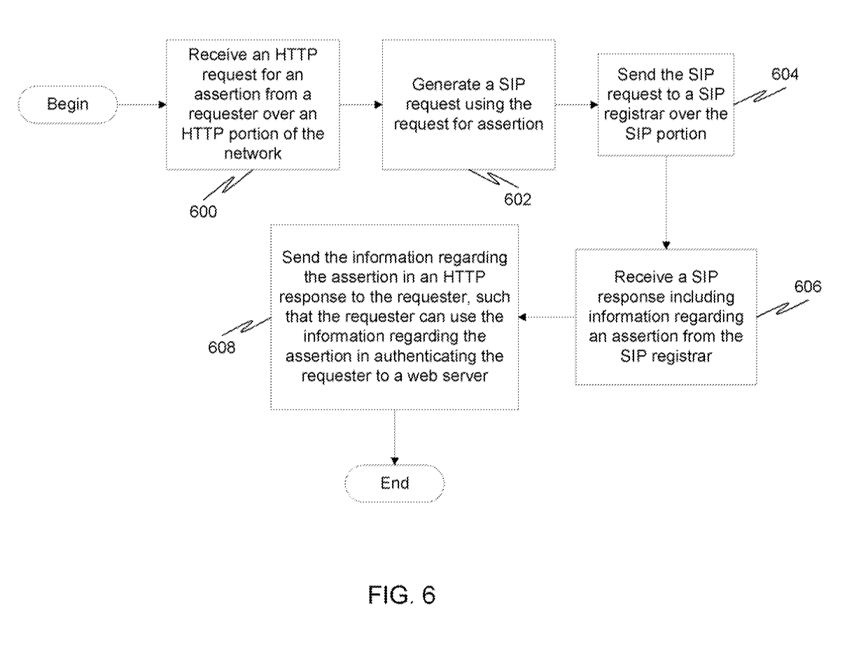

FIG. 6 is a flow diagram illustrating a generic method covering both the first and the second subembodiments of the first embodiment of the present invention. This method may be performed by a gateway. At 600, an HTTP request for an assertion is received from a requester over an HTTP portion of a network. At 602, a SIP request is generated using the request for assertion. This may include encapsulating a SAML assertion request in a SOAP message which is itself encapsulated in the SIP request. At 604, the SIP request is sent to a SIP registrar over the SIP portion. At 606, a SIP response including information regarding an assertion is received from the SIP registrar. In the case of the first subembodiment (assertion by value), the information is actually a copy of the assertion itself, whereas in the case of the second subembodiment (assertion fetch), the information is a link indicating where a copy of the assertion can be retrieved. In both cases, the information may be encapsulated in a SOAP message which itself is encapsulated in the SIP response. At 608, the information regarding the assertion may be sent in an HTTP response to the requester, such that the requester can use the information regarding the assertion in authenticating the requester to a web server.

In the second main embodiment of the present invention, as described above, the assertion generation process is delegated from the SIP registrar to the IG. As part of this, trusted module (TM) functionality in the IG is utilized. Trusted module (also known as Trusted Platform Module) offers facilities for the secure generation of cryptographic keys, and limitation of their use, in addition to a hardware pseudo-random number generator. It also includes capabilities such as remote attestation and sealed storage. “Remote attestation” creates a nearly unforgeable hash key summary of the hardware and software configuration. The extent of the summary of the software is decided by the program encrypting the data. This allows a third party to verify that the software has not been changed. “Binding” encrypts data using the endorsement key, a unique RSA key burned into the chip during its production, or another trusted key descended from it. “Sealing” encrypts data similar to binding, but in addition specifies a state in which the TPM must be in order for the data to be decrypted (unsealed). A Trusted Module can be used to authenticate hardware devices. Since each TM chip has a unique and secret RSA key burned in as it is produced, it is capable of performing platform authentication. For example, it can be used to verify that a system seeking access is the expected system.

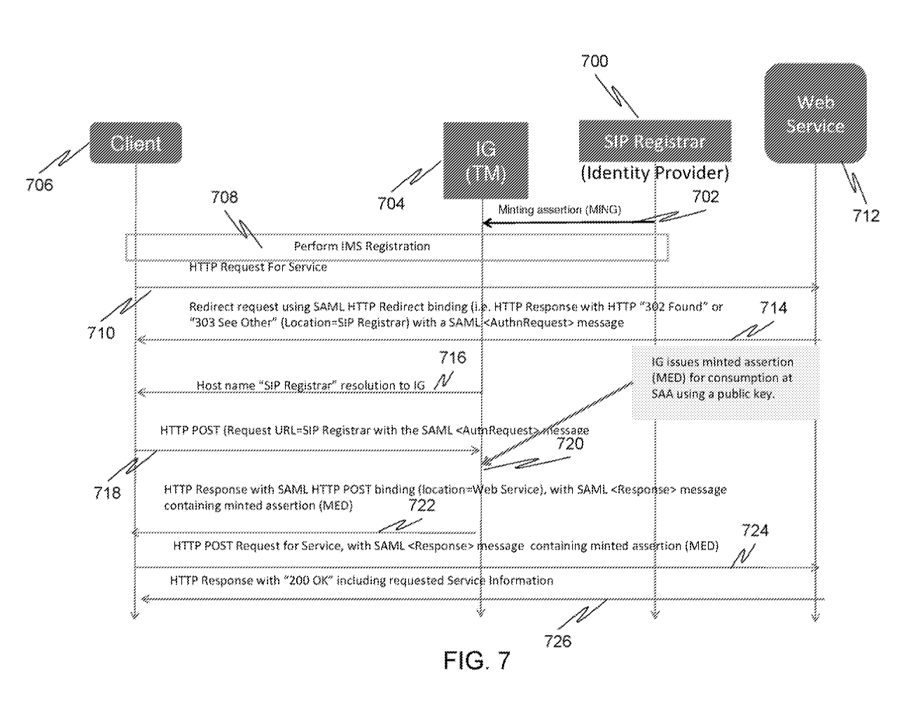

The requester sends a request for a resource to the web server. The web server returns a redirect request message using SAML HTTP redirect binding with a SAML authentication request message to requester. The IG acts as a local Domain Name Service (DNS) proxy to make the SIP registrar well known to the local gateway IP address. The requester then does a DNS lookup that resolves the SIP registrar to the IG. The Requester than sends a SAML authentication request message through an HTTP post message to the IG with the identity of both the web server and the requester. The Trusted Module then generates a minted assertion and signs it with a web server specific public key. Here is may be assumed that the requester has already authenticated with the SIP registrar and the trusted module has obtained a minting assertion from the SIP registrar. The IG then creates an HTTP response message with HTTP response post binding with the SAML response message containing the minted assertion. The Request then sends an HTTP post request message with the SAML response containing the minted assertion. The web server then verifies the authenticity of the user and responds with an OK message containing the requested service. This is depicted in FIG. 7.

SIP registrar 700 provides a minting assertion 702 to the IG 704. Client 706 can then perform IMS registration 708 with the SIP registrar 700. Subsequently, client 706 can issue an HTTP request for service 710 to the web service 712. The web service 712 issues an HTTP response 714 that includes a redirect request, which includes a SAML authorization request message. The client 706 then looks up the SIP registrar hostname at the IG 704 and receives an IG address 716 corresponding to the SIP registrar 700. The client 706 then issues an HTTP request 718 with the SAML authorization request message containing to the appropriate IG 404. This is communicated via the HTTP protocol. IG 704 then issues a minted assertion 720 for consumption at the web service 712 using a public key. The Minted assertion is returned to the client 706 in an HTTP response message 722.

The client 706 can then send a request for service 724, including the minted assertion, via HTTP directly to the web service 712. The web service 712 can authenticate the client 706 using this minted assertion and send back an HTTP response message including requested service information 726.

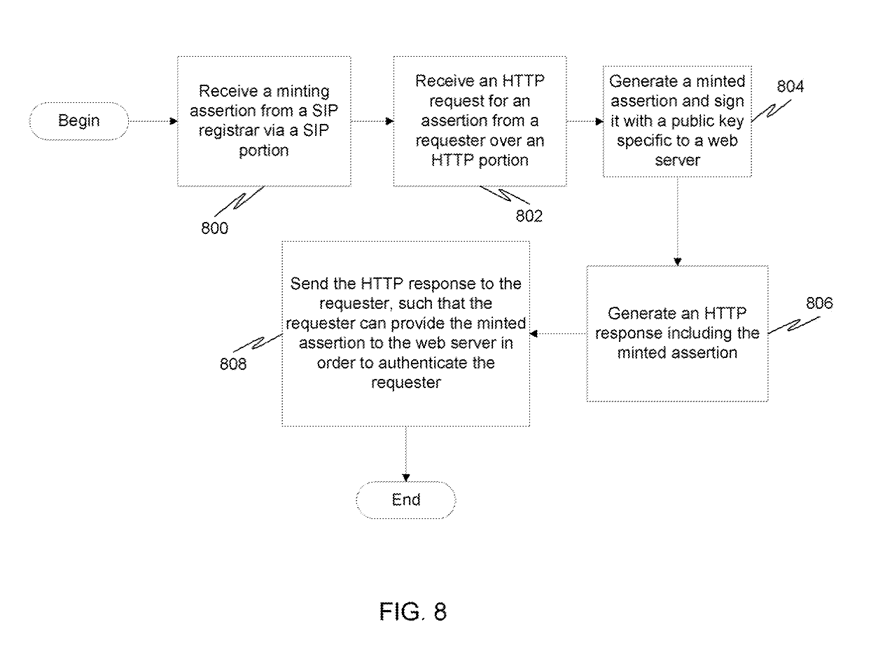

FIG. 8 is a flow diagram illustrating a method for providing single-sign on in accordance with the second main embodiment of the present invention (delegation). This method may be performed by a gateway. At 800, a minting assertion is received from a SIP registrar via a SIP portion. At 802, an HTTP request for an assertion is received from a requester over an HTTP portion. At 804, a minted assertion is generated and signed with a public key specific to a web server. This may utilize an identification of the requester and an identification of the web server. The generating may be performed by a trusted module on the gateway. At 806, an HTTP response is generated including the minted assertion. At 808, the HTTP response is sent to the requester, such that the requester can provide the minted assertion to the web server in order to authenticate the requester.

This second main embodiment eliminates the need to embed the SAML request or response in a SOAP message. Since SAML is only used for communications between the IG and the requester, SAML-HTTP can be utilized.

All of the embodiments of the present invention provide new functionality in the IG that allows foe the authentication of a requester (such as an OITF terminal) to a web server using the credentials used to authenticate the requester to a SIP server. The use of the IG as a gateway between the HTTP and SIP sections bridges the identify chasm between the HTTP and SIP portions and allows for the continuity of a HTTP session using the SIP credentials. While multiple different methods are provided herein to achieve those results, both profiles involve implementing new functionality in an IG.

The various aspects, features, embodiments or implementations of the invention described above can be used alone or in various combinations. The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for providing single sign-on in a network having a HyperText Transfer Protocol (HTTP) portion and a Session Initiation Protocol (SIP) portion, the method performed at a gateway and comprising:
receiving an HTTP request for an assertion from a requester over the HTTP portion;
generating a SIP request using the request for assertion;
sending the SIP request to a SIP registrar over the SIP portion;
receiving a SIP response including information regarding an assertion from the SIP registrar; and
sending the information regarding the assertion in an HTTP response to the requester, such that the requester can use the information regarding the assertion in authenticating the requester to a web server.

2. The method of claim 1, wherein the information regarding an assertion is the assertion itself and SIP response includes a Simple Object Access Protocol (SOAP) message embedded within it, wherein a body of the SOAP message includes the assertion.

3. The method of claim 1, wherein the information regarding an assertion is a uniform resource identifier (URI) indicating a location where the assertion can be retrieved, such that the requester can send the URI to the web server in a manner that allows the web server to authenticate the requester by retrieving and examining the assertion at the URI.

4. The method of claim 1, wherein the assertion is a Simple Abstract Request/Response (SAML) assertion.

5. A method for providing single sign-on in a network having a HyperText Transfer Protocol (HTTP) portion and a Session Initiation Protocol (SIP) portion, the method performed at a gateway and comprising:
receiving a minting assertion from a SIP registrar via the SIP portion;
receiving an HTTP request for an assertion from a requester over the HTTP portion;
generating a minted assertion and signing the minted assertion with a public key specific to a web server;
generating an HTTP response including the minted assertion; and
sending the HTTP response to the requester, such that the requester can provide the minted assertion to the web server in order to authenticate the requester.

6. The method of claim 5, wherein the generating a minted assertion uses an identification of the requester and an identification of the web server.

7. The method of claim 5, wherein the generating a minted assertion is performed by a trusted module on the gateway.

8. A system comprising:
a requesting device;
a gateway connected to the requesting device via an HTTP link;
a SIP registrar connected to the gateway via a SIP link;
wherein the gateway is configured to:
receive an HTTP request for an assertion from a requester over the HTTP link;
generate a SIP request using the request for assertion;
send the SIP request to a SIP registrar over the SIP link;
receive a SIP response including information regarding an assertion from the SIP registrar; and
send the information regarding the assertion in an HTTP response to the requester, such that the requester can use the information regarding the assertion in authenticating the requester to a web server.

9. The system of claim 8, wherein the requester is configured to send the information regarding the assertion received from the gateway to a web server in order to automatically obtain access to the web service without needing to re-enter password information.

10. The system of claim 9, wherein the SIP registrar is configured to operate with the web service to provide assertions compatible with the web service.

11. A system comprising:
a requesting device;
a gateway connected to the requesting device via an HTTP link;
a SIP registrar connected to the gateway via a SIP link;
wherein the gateway is configured to:
receive a minting assertion from a SIP registrar via the SIP link;
receive an HTTP request for an assertion from a requester over the HTTP link;
generate a minted assertion and signing the minted assertion with a public key specific to a web server;
generate an HTTP response including the minted assertion; and
send the HTTP response to the requester, such that the requester can provide the minted assertion to the web server in order to authenticate the requester.

12. The system of claim 11, wherein the SIP portion is part of a mobile phone network.

13. The system of claim 11, wherein the requesting device is a mobile phone.

14. A gateway for providing single sign-on in a network having a HyperText Transfer Protocol (HTTP) portion and a Session Initiation Protocol (SIP) portion, the gateway comprising:
means for receiving an HTTP request for an assertion from a requester over the HTTP portion;
means for generating a SIP request using the request for assertion;
means for sending the SIP request to a SIP registrar over the SIP portion;
means for receiving a SIP response including information regarding an assertion from the SIP registrar; and
means for sending the information regarding the assertion in an HTTP response to the requester, such that the requester can use the information regarding the assertion in authenticating the requester to a web server.

15. The gateway of claim 14, wherein the information regarding an assertion is the assertion itself and SIP response includes a Simple Object Access Protocol (SOAP) message embedded within it, wherein a body of the SOAP message includes the assertion.

16. The gateway of claim 14, wherein the information regarding an assertion is a uniform resource identifier (URI) indicating a location where the assertion can be retrieved, such that the requester can send the URI to the web server in a manner that allows the web server to authenticate the requester by retrieving and examining the assertion at the URI.

17. A gateway for providing single sign-on in a network having a HyperText Transfer Protocol (HTTP) portion and a Session Initiation Protocol (SIP) portion, the gateway comprising:
means for receiving a minting assertion from a SIP registrar via the SIP portion;
means for receiving an HTTP request for an assertion from a requester over the HTTP portion;
means for generating a minted assertion and signing the minted assertion with a public key specific to a web server;
means for generating an HTTP response including the minted assertion; and
means for sending the HTTP response to the requester, such that the requester can provide the minted assertion to the web server in order to authenticate the requester.

18. The gateway of claim 17, wherein the means for generating a minted assertion is a trusted module.

19. A program storage cloud platform readable by a machine tangibly embodying a program of instructions executable by the machine to perform a method for providing single sign-on in a network having a HyperText Transfer Protocol (HTTP) portion and a comprising:
receiving an HTTP request for an assertion from a requester over the HTTP portion;
generating a SIP request using the request for assertion;
sending the SIP request to a SIP registrar over the SIP portion;
receiving a SIP response including information regarding an assertion from the SIP registrar; and
sending the information regarding the assertion in an HTTP response to the requester, such that the requester can use the information regarding the assertion in authenticating the requester to a web server.

20. A program storage cloud platform readable by a machine tangibly embodying a program of instructions executable by the machine to perform a method for providing single sign-on in a network having a HyperText Transfer Protocol (HTTP) portion and a Session Initiation Protocol (SIP) portion, the method performed at a gateway and comprising:
receiving a minting assertion from a SIP registrar via the SIP portion;
receiving an HTTP request for an assertion from a requester over the HTTP portion;
generating a minted assertion and signing the minted assertion with a public key specific to a web server;
generating an HTTP response including the minted assertion; and
sending the HTTP response to the requester, such that the requester can provide the minted assertion to the web server in order to authenticate the requester.
